(19) United States
(12) Patent Application Publication
(10) Pub. No.: US 2026/0183778 A1
(43) Pub. Date: Jul. 2, 2026

(54) DISPENSER WITH SPRAY APPLICATOR

(71) Applicant: medmix Switzerland AG, Haag (Rheintal) (CH)

(72) Inventors: Mark TINKLER, Thatcham (GB); Nick FITTON, Swindon (GB); Stephen DONLON, Brentford (GB); Matt LYNDON, Chandlers Ford (GB)

(21) Appl. No.: 19/131,210

(22) PCT Filed: Nov. 29, 2023
(86) PCT No.: PCT/EP2023/083481

§ 371 Date: May 20, 2025

(30) Foreign Application Priority Data
Nov. 29, 2022 (GB) 2217907.1

(51) Int. Cl. B05B 9/08; B05C 1/06; B05C 1/08; B05C 11/10; B05C 17/00; B05C 17/03; B05C 17/035; B24B 29/00

(52) U.S. Cl. CPC B05B 9/0838; B05B 9/0816; B05C 1/06; B05C 1/0813; B05C 11/1026; B05C 17/002; B05C 17/0308; B05C 17/0325; B05C 17/0357; B24B 29/00

(57) ABSTRACT

A dispenser dispensing a component of material includes a cartridge to store the material to be dispensed, a dispensing mechanism to urge the material towards an outlet of the cartridge, a trigger configured to activate the dispensing mechanism, and a connection device at a dispensing end of the dispenser to connect the dispenser to a spray applicator, with the spray applicator spraying the material out of the cartridge.

### CROSS-REFERENCE TO RELATED APPLICATION

This application is a U.S. national stage application of International Application No. PCT/EP 2023/083481, filed on Nov. 29, 2023, which claims priority to GB Application No. 2217907.1, filed on Nov. 29, 2022, the contents of each of which are hereby incorporated by reference.

### BACKGROUND

### Technical Field

The disclosure relates to a dispenser for dispensing at least one component of material.

### Background Information

Various dispensers for dispensing, in particular spraying, low viscosity materials are commonly known and widely used in a variety of different fields of application.

Such known spray dispensers often comprise pressurized cans and/or cartridges that upon use of the dispensers can spray the material stored therein out of the cartridge and/or the can by releasing at least part of the pressure.

### SUMMARY

Many of the products contained in these cans or cartridges, such as paint products, light lubricants, starting fluids, polishes and waxes, and cleaners, contain substantial amounts of volatile organic compounds (VOCs) as solvents and include flammable propellants. As a result, partially empty cans or cartridges have to be treated as a hazardous waste. Such hazardous waste cannot be disposed easily, let alone recycled in any way.

It is therefore an object of the disclosure to provide a dispenser for dispensing, in particular spraying, materials with which such drawbacks can be overcome. This object is solved by the subject matter of the independent claims.

According to a first aspect of the disclosure a dispenser for dispensing at least one component of material is provided, with the dispenser comprising at least one cartridge configured to store the material to be dispensed, a dispensing mechanism configured to urge the material towards an outlet of the cartridge and a trigger configured to activate the dispensing mechanism. The dispenser according to the disclosure further comprises connection means at a dispensing end of the dispenser, in particular at the outlet of the cartridge, configured to, in particular releasably, connect the dispenser to a spray applicator, with the spray applicator being configured to spray the material out of the cartridge.

By providing a spray applicator that can be (releasably) attached to the dispenser according to the disclosure, it is not necessary anymore to pressurize the cans or cartridges that comprise the material to be sprayed as the dispenser according to the disclosure is configured to urge the material stored inside the cartridge towards the spray applicator which ultimately sprays the material onto a surface.

Furthermore, with the dispenser according to the disclosure, once the cartridge is empty or useless, only the cartridge needs to be replaced while the dispenser including the spray applicator can be reused with a new cartridge. Hence, the amount of (hazardous) waste can be reduced, thereby leading to a more sustainable solution.

According to an embodiment of the disclosure the dispenser is one of a manual, electrical, in particular cordless, and pneumatic dispenser. That is, the dispenser can either be driven by manual, electrical or pneumatic power.

According to another embodiment the trigger is configured to enable a longitudinal movement of the piston towards the outlet of the cartridge to urge the material stored inside the cartridge towards the outlet.

According to a further embodiment the cartridge comprises a solid head part and a flexible cartridge container being sealingly connected to the solid head part, with the head part comprising the outlet of the cartridge. The advantage of a flexible cartridge is that such cartridges can further reduce the amount of waste that is produced upon use of the dispenser as the dispenser can for example be configured to squeeze the material stored inside the cartridge out of the head part such that the residual waste, once the cartridge is emptied, amounts only in a compressed flexible cartridge of a small volume. Compared to the volumes of solid cartridges this makes a huge difference.

The flexible container can be formed of a film material.

Furthermore, the film material can be formed of two or more layers with the layers being made of the same or different materials. Typical film materials can be for example polyethylene, polypropylene, polyamide, polyethylene terephthalate, polybutylene terephthalate, Cyclic olefin copolymer (COC), Polylactid Acid (PLA), Polystyrene (PS), Polyvinylidene dichloride (PVDC), Polyvinylidene dichloride (PVC), Paper, Aluminium and/or combinations of the foregoing. The precise type of film material can also be selected according to the application, for example in accordance with the material that is supposed to be stored inside the cartridge.

According to a further embodiment the flexible container comprises one of a round, oval, rectangular, square, triangular, polygonal cross section. That is, the dispenser according to the disclosure is not limited to cartridges of a certain cross section but can rather be used together with cartridges of different cross sections.

A cross section of the flexible container can further be essentially constant along a longitudinal length of the flexible container. That is, the flexible container can comprise an essentially uniform shape along its longitudinal length.

According to an alternative embodiment the cartridge comprises a solid cartridge container and a solid head part, with the head part in particular being integrally formed with the container. Hence, according to this embodiment the cartridge can be stable in itself such that it will not be compressed upon use of the dispenser.

Either way, the material stored inside the cartridge can either be one of low viscosity or higher viscosity material.

According to a further embodiment the cartridge comprises an inner volume selected in the range of 100 ml to 10 l. That is, the cartridge size can be chosen according the precise application of the dispenser.

According to another embodiment the dispenser further comprises carrying means configured to enable on-body carrying of the dispenser. Such carrying means can allow a user to carry the dispenser while only needing to hold the spray applicator in their hand, thereby allowing an easier and more efficient use of the dispenser.

The carrying means can be one of a clip, in particular a belt clip, a strap, in particular a shoulder strap, a belt, a sling, a buckle and/or combinations of the foregoing. Hence, a variety of different carrying means can be chosen as long as they are configured to allow on-body carrying of the dispenser.

According to a further embodiment the dispenser comprises a support sleeve configured to receive the cartridge and a piston configured to apply a pressure onto a rear end of the cartridge to urge the material stored inside the cartridge towards its outlet. In the case of a flexible cartridge, the piston can be configured such that it compresses the cartridge to urge the material towards the outlet. Alternatively, in the case of a solid cartridge, the piston can be configured such that it seals a rear part of the cartridge such that it directly compresses the material inside the cartridge to urge it towards the outlet.

According to another embodiment the spray applicator comprises a valve assembly arranged at a dispensing end of the dispenser and configured to spray the material out of the dispenser. The valve assembly can be configured to control the spray application of the dispenser. That is, it can be configured to prevent and/or allow a spray application and/or to configured to control an amount of material that is supposed to be sprayed.

The valve assembly can further be configured to be controlled by a lever, a rotary control element and/or a press control element. Such elements have proven to be user-friendly such that a simple application of the dispenser can be allowed.

According to another embodiment the spay applicator further comprises a lever configured to activate the spray applicator and connectable to the spray applicator, in particular the valve assembly, upon use of the dispenser. The lever can either be configured to only activate the spray applicator, the valve assembly, and/or the complete dispenser.

That is, it can be possible that the lever is only configured to activate the spray applicator without being able to activate the complete dispenser. That is, according to such an embodiment the activation of the dispenser and the activation of the spray applicator are disconnected from one another. This way it can be possible to activate the dispenser, for example through the use of a trigger, such that the material is urged towards the outlet and pressure is built up inside the cartridge until the lever is activated to spray the material out of the spray applicator, thereby releasing the pressure from the cartridge.

The lever can further comprise a locking mechanism configured to lock the lever in at least one of a spraying and storing position. Such a locking mechanism can allow an easier handling of the dispenser as the lever does not constantly need to be held in its respective position by the user.

The lever can further be configured to continue spraying the material out of the dispenser as long as the lever is activated. That is, according to this embodiment the material stored inside the cartridge is sprayed out of the spray dispenser as long as the lever is activated.

Alternatively, it may also be possible that an activation of the lever only releases a puff of material, i.e. a short quick blast of material, independently of how long the lever is activated.

According to a further embodiment the spray applicator further comprises a spraying nozzle with the spraying nozzle being connectable to the spray applicator. Such a spraying nozzle can enhance the spray quality of the spray applicator such that an even spread of material can be made possible.

In this connection it is noted that it can be possible that the lever is arranged at the spraying nozzle. That is, according to this embodiment the lever can be arranged at the spraying nozzle, i.e. in the close vicinity of the spraying nozzle, and to directly influence the spraying nozzle upon activation/deactivation of the lever.

According to an embodiment the spray applicator is connected to the dispenser via a tube, in particular a flexible tube, with a length of the tube being selected in the range of 2 cm to 2 m. This way, the spray applicator can be handled almost independently from the dispenser, in particular the cartridge, to allow an easier use of the spray applicator in order make it easier to reach, for example, corners or other difficult to reach places.

The tube can be detachable upon use of the spray applicator. That is, as already mentioned earlier in connection with another embodiment, it can be possible to build up pressure in the cartridge and/or the spray applicator upon use of the dispenser which can be later released upon use of the spray applicator. By providing a detachable spray applicator, the pressure can be released, i.e. the material can be sprayed, without the need to carry the whole dispenser or to stay next to the cartridge and the rest of the dispenser. This can allow a user to reach places with the spray applicator which may not be reachable with a conventional dispenser.

According to a further embodiment the spray applicator comprises an extension pipe configured to extend a length between at least a part of the spray applicator, in particular the complete spray applicator, and the other parts of the dispenser. That is, it can be possible to extend a length between the dispenser itself and its dispensing end, i.e. for example a spraying nozzle of the spray applicator, to allow an easier handling of the dispenser.

According to a further embodiment the spray applicator comprises a brush arranged at a dispensing end of the dispenser, in particular close to the spraying nozzle of the dispenser. For some applications it can advantageous if the material stored inside the cartridge can be spread onto a surface with a brush. By providing such a brush directly at the spray applicator, the two work steps of distributing the material onto a surface and then spread it out evenly with a brush can be combined to a single work step.

In this connection it is noted that the spraying nozzle can be arranged next to the brush. That is, it can be possible to provide both a spraying nozzle and a brush which are arranged next to one another such that the step of spraying the material and spreading it out evenly with the brush can be carried out at the same time.

According to an alternative embodiment the brush is fed with material by the spray applicator. According to this embodiment the material does not necessarily have to be sprayed onto the brush but can rather be fed directly into the brush.

According to a further embodiment the dispenser can comprise a flow control valve configured to regulate the flow of material towards the brush. The flow control valve can either be arranged at, i.e. next to, the spray applicator or at, i.e. next to, the dispenser. Further, the flow control valve can be configured to regulate an amount of material that can flow towards the brush such that a user can predetermine how much material can flow towards the brush at any given time.

The brush can also be releasably attachable to the spray applicator, thereby ensuring that the brush can for example be replaced with another element configured to spread out the material to be sprayed out.

According to a further embodiment the spray applicator additionally comprises a roller onto which the material is sprayed, with the roller being configured to evenly distribute the material onto a surface. In some embodiments, such as for example painting jobs, it can be advantageous to provide a roller that is configured to evenly distribute the material onto a surface. In this connection the material stored inside the cartridge can be sprayed onto the roller to apply the material onto an outer surface of the roller.

According to an alternative embodiment the spray applicator additionally comprises a roller which is fed with material by the spray applicator, with the roller being configured to evenly distribute the material onto a surface. That is, compared to the above embodiment, this time the roller is fed with material the roller instead of the material being sprayed onto an outer surface of the roller.

In this connection it can be possible that the spray applicator is configured to feed the roller at a central axis of the roller with the axis extending along a longitudinal length of the roller.

It can further be possible that the roller is releasably connectable to the spray applicator. Hence, it can be possible that the roller can, for example, be replaced with another element for spreading out the material or to use the spray applicator without a further element.

According to a further embodiment the spray applicator comprises a polishing tool configured to evenly distribute the material onto a surface. Such a polishing tool can help distribute the material to be dispensed onto delicate surfaces that are supposed to be polished with the material.

In this connection it can be possible that the spraying nozzle is arranged next to the polishing tool. According to such an embodiment the step of spraying the material onto a surface and spreading it out evenly with the polishing tool can be carried out at the same time thereby making the handling of the dispenser easier.

It can also be possible that the polishing tool is releasably attachable to the spray applicator. This way the polishing tool can for example be replaced with another element to evenly spread out the material onto a surface or to use the spray applicator without a further element.

According to a further embodiment the polishing tool is configured to vibrate and/or move back and forth and/or rotate upon use of the dispenser. Such additional movement of the polishing tool can support the polishing of a surface.

According to another embodiment the dispenser further comprises a telescopic arm configured to extend a length between the dispenser and at least the spray applicator, thereby enabling an easier handling of the dispenser in case hard to reach surfaces are supposed to be covered with the material.

According to another aspect of the disclosure a dispenser for dispensing at least one component of material is provided comprising at least one tank configured to store the material to be dispensed, a dispensing mechanism configured to urge the material towards an outlet of the tank, and a trigger configured to activate the dispensing mechanism. The dispenser further comprises connection means at the outlet of the tank configured to, in particular releasably, connect the dispenser to a spray applicator, with the applicator being configured to spray the material out of the tank.

By providing a spray applicator that can be (releasably) attached to the dispenser according to the disclosure, it is not necessary anymore to pressurize cans or cartridges that comprise the material to be sprayed as the dispenser according to the disclosure is configured to urge the material stored inside the tank towards the spray applicator which ultimately sprays the material onto a surface.

Furthermore, with the dispenser according to the disclosure, once the tank is empty, the tank only needs to be replaced or refilled while the dispenser per se including the spray applicator can be reused with the new/refilled tank. Hence, the amount of (hazardous) waste can be reduced, thereby leading to a more sustainable solution.

Also, by providing a tank that can hold a great amount of material the dispenser according to the disclosure can be used for a longer time as such a tank is not emptied easily.

According to an embodiment of the disclosure the tank is configured to be pressurized by one of a manual pump, an electrical pump, a central air supply or pressurized bottles. That is, by pressurizing the tank with one of the above options, the material stored inside the tank can be urged towards the spray applicator which then sprays the material, e.g. onto a surface. Hence, the tank does not need to be pressurized at all times but only upon use which can be done by providing, for example, a manual or electrical pump, a central air supply or pressurized bottles.

According to another embodiment the dispenser further comprises a cartridge being configured to store at least a second material and with the cartridge further being configured to be, in particular releasably, connectable to the spray applicator and/or to the tank, in particular wherein the cartridge comprises a solid head part and a flexible cartridge container being sealingly connected to the solid head part, with the head part comprising the outlet of the cartridge.

That is, according to this embodiment the dispenser can comprise not only a tank but also a cartridge that stores a second material such that upon use of the dispenser both materials can be sprayed out of the spray applicator. In this connection it is noted that it can be possible that both materials are sprayed at the same time or also independently from one another. Also, it could be possible to mix the two materials prior to the materials being sprayed, e.g. using a static mixer or the like.

In this connection it is also noted that generally the tank comprises a larger volume than the cartridge. Nevertheless, it could also be possible that the tank and the cartridge comprise the same volume or that the cartridge comprises an even larger volume than the tank.

The two materials stored in the tank respectively the cartridge usually differ from one another. For example, it can be possible that the tank stores water while the cartridge stores some kind of cleaning agent that is mixed with the water upon use of the dispenser.

In some applications it can however also be possible that the tank and the cartridge store the same or generally the same material.

Furthermore, it can also be possible that the cartridge comprises a flexible cartridge container and a solid head part that is sealingly connected to the flexible container and that comprises an outlet. Such flexible cartridge containers have the advantage that they can be replaced rather easily once they are empty without having to exchange the complete cartridge.

In this connection it is also noted that the flexible container can be formed of a film material.

Also, the film material can be formed of two or more layers of film with the layers being made of the same or different materials. Typical film materials can be for example polyethylene, polypropylene, polyamide, polyethylene terephthalate, poly butylene terephthalate, Cyclic olefin copolymer (COC), Polylactid Acid (PLA), Polystyrene (PS), Polyvinylidene dichloride (PVDC), Polyvinylidene dichloride (PVC), Paper, Aluminium and/or combinations of the foregoing. The precise type of film material can also be selected according to the application, for example in accordance with the material that is supposed to be stored inside the cartridge

According to a further embodiment the flexible container comprises one of a round, oval, rectangular, square, triangular, polygonal cross section.

It can also be possible that a cross section of the flexible container is essentially constant along a longitudinal length of the flexible container such that a container of a generally uniform shape can be provided.

According to an alternative embodiment the cartridge comprises a solid cartridge container and a solid head part, with the head part in particular being integrally formed with the container.

It can further be possible that the material stored inside the tank and/or the cartridge is one of low viscosity or higher viscosity material.

According to a further embodiment the tank and/or the cartridge comprises an inner volume selected in the range of 100 ml to 100 l. Usually, the tank comprises a substantially greater volume than the cartridge with the cartridge comprising a volume selected in the range of 100 ml to 500 ml and the tank comprising a volume of 5 l to 100 l as often the two materials are mixed with one another at a ratio in the range of 1:1 to 100:1.

The dispenser can further comprise carrying means configured to enable on-body carrying of the spray applicator. That is, upon use of the dispenser a user can carry the spray applicator on the body while the tank can be left on the floor or at any other suitable place. This is especially advantageous when the tank is filled with up to 100 l of material making it at least very difficult for a user to carry the tank with them.

The carrying means can for example be one of a clip, in particular a belt clip, a strap, in particular a shoulder strap, a belt, a sling, a buckle and/or combinations of the foregoing.

According to a further embodiment the spray applicator comprises a valve assembly arranged at a dispensing end of the dispenser and configured to spray the material out of the dispenser. The valve assembly can be configured to control the spray application of the dispenser. That is, it can be configured to prevent and/or allow a spray application and/or to configured to control an amount of material that is supposed to be sprayed.

The valve assembly can further be configured to be controlled by a lever, a rotary control element and/or a press control element. Such elements have proven to be user-friendly such that a simple application of the dispenser can be allowed.

According to another embodiment the spay applicator further comprises a lever configured to activate the spray applicator and connectable to the spray applicator, in particular the valve assembly, upon use of the dispenser. The lever can either be configured to only activate the spray applicator, the valve assembly and/or the complete dispenser.

That is, it can be possible that the lever is only configured to activate the spray applicator without being able to activate the complete dispenser. That is, according to such an embodiment the activation of the dispenser and the activation of the spray applicator are disconnected from one another. This way it can be possible to activate the dispenser, for example through the use of a trigger, such that the material is urged towards the outlet and pressure is build up inside the cartridge and/or the tank until the lever is activated to spray the material out of the spray applicator, thereby releasing the pressure from the cartridge and/or the tank.

The lever can further comprise a locking mechanism configured to lock the lever in at least one of a spraying and storing position. Such a locking mechanism can allow an easier handling of the dispenser as the lever does not constantly need to be held in its respective position by the user.

The lever can further be configured to continue spraying the material out of the dispenser as long as the lever is activated. That is, according to this embodiment the material stored inside the tank and/or the cartridge is sprayed out of the spray dispenser as long as the lever is activated.

Alternatively, it can also be possible that an activation of the lever only releases puffs of material independently of how long the lever is activated.

According to a further embodiment the spray applicator further comprises a spraying nozzle with the spraying nozzle being connectable to the spray applicator. Such a spraying nozzle can enhance the spray quality of the spray applicator such that an even spread of material can be made possible.

In this connection it is noted that it can be possible that the lever is arranged at the spraying nozzle. That is, according to this embodiment the lever can be arranged in the near vicinity of the spraying nozzle and to directly influence the spraying nozzle upon activation/deactivation of the lever.

According to an embodiment the spray applicator is connected to the dispenser via a tube, in particular a flexible tube, with a length of the tube being selected in the range of 5 cm to 2 m. This way, the spray applicator can be handled almost independently from the dispenser, in particular the tank, to allow an easier use of the spray applicator in order make it easier to reach, for example, corners or other difficult to reach places.

The tube can be detachable upon use of the spray applicator. That is, as already mentioned earlier in connection with another embodiment, it can be possible to build up pressure in the tank and/or the spray applicator upon use of the dispenser which can be later released upon use of the spray applicator. By providing a detachable spray applicator, the pressure can be released, i.e. the material can be sprayed, without the need to carry the whole dispenser or without the need to stay next to the tank. This can allow a user to reach places with the spray applicator which may not be reachable with a conventional dispenser.

According to a further embodiment the spray applicator comprises an extension pipe configured to extend a length between at least a part of the spray applicator, in particular the complete spray applicator, and the other parts of the dispenser. That is, it can be possible to extend a length between the dispenser itself and its dispensing end, i.e. for example a spraying nozzle of the spray applicator, to allow an easier handling of the dispenser.

According to a further embodiment the spray applicator comprises a brush arranged at a dispensing end of the dispenser, in particular close to the spraying nozzle of the dispenser. For some applications it can advantageous if the material stored inside the tank can be spread onto a surface with a brush. By providing such a brush directly at the spray applicator, the two work steps of distributing the material onto a surface and then spread it out evenly with a brush can be combined to a single work step.

In this connection it is noted that the spraying nozzle can be arranged next to the brush. That is, it can be possible to provide both a spraying nozzle and a brush which are arranged next to one another such that the step of spraying the material and spreading it out evenly with the brush can be carried out at the same time.

According to an alternative embodiment the brush is fed with material by the spray applicator. According to this embodiment the material does not necessarily have to be sprayed onto the brush but can rather be fed directly into the brush.

According to a further embodiment the dispenser can comprise a flow control valve configured to regulate the flow of material towards the brush. The flow control valve can either be arranged at, i.e. next to, the spray applicator or at, i.e. next to, the dispenser, in particular the tank. Further, the flow control valve can be configured to regulate an amount of material that can flow towards the brush such that a user can predetermine how much material can flow towards the brush at any given time.

The brush can also be releasably attachable to the spray applicator, thereby ensuring that the brush can for example be replaced with another element configured to spread out the material to be sprayed out.

According to a further embodiment the spray applicator additionally comprises a roller onto which the material is sprayed, with the roller being configured to evenly distribute the material onto a surface. In some embodiments, such as for example painting jobs, it can be advantageous to provide a roller that is configured to evenly distribute the material onto a surface. In this connection the material stored inside the cartridge can be sprayed onto the roller to apply the material onto an outer surface of the roller.

According to an alternative embodiment the spray applicator additionally comprises a roller which is fed with material by the spray applicator, with the roller being configured to evenly distribute the material onto a surface. That is, compared to the above embodiment, this time the roller is fed with material the roller instead of the material being sprayed onto an outer surface of the roller.

In this connection it can be possible that the spray applicator is configured to feed the roller at a central axis of the roller with the axis extending along a longitudinal length of the roller.

It can further be possible that the roller is releasably connectable to the spray applicator. Hence, it can be possible that the roller can, for example, be replaced with another element for spreading out the material or to use the spray applicator without a further element.

According to a further embodiment the spray applicator comprises a polishing tool configured to evenly distribute the material onto a surface. Such a polishing tool can help distribute the material to be dispensed onto delicate surfaces that are supposed to be polished with the material.

It can also be possible that the polishing tool is releasably attachable to the spray applicator. This way the polishing tool can for example be replaced with another element to evenly spread out the material onto a surface or to use the spray applicator without a further element.

According to a further embodiment the polishing tool is configured to vibrate and/or move back and forth and/or rotate upon use of the dispenser. Such additional movement of the polishing tool can support the polishing of a surface.

According to another embodiment the dispenser further comprises a telescopic arm configured to extend a length between the dispenser and at least the spray applicator, thereby enabling an easier handling of the dispenser in case hard to reach surfaces are supposed to be covered with the material.

It can further be possible that the dispenser according to the disclosure, in particular according to both of the above aspects of the disclosure, comprise two or more of the above additional spreading-elements, i.e. the roller, the polishing tool, the brush etc., that can be releasably attached to the spray applicator such that they can be exchanged with one another depending on the application of the dispenser. Thereby a single dispenser can be used for a variety of different applications.

According to a further aspect of the disclosure a dispenser for dispensing at least one component of material is provided. The dispenser comprising at least one tank configured to store a first component to be dispensed, a dispensing mechanism configured to urge the material towards an outlet of the tank, and a trigger configured to activate the dispensing mechanism. The dispenser further comprises connection means at the outlet of the tank configured to, in particular releasably, connect the dispenser to a spray applicator, with the applicator being configured to spray the material out of the tank and with the spray applicator further comprising at least one cartridge, with the cartridge comprising a second component to be dispensed, wherein the dispenser is at least configured to dispense each component independently from one another.

Hence, according to this third aspect of the disclosure the dispenser comprises not only a tank configured to store a first material but also a cartridge that is configured to store a second material such that then each component can be dispensed, in particular sprayed, out of the dispenser independently from one another.

It can also be possible that the dispenser is configured to dispense both components simultaneously. In this connection the two components can be mixed with one another while being sprayed.

According to another embodiment the dispenser is configured to mix the component stored in the tank with the component stored in the cartridge prior to dispensing the components. This can for example be the case when the tank stores water while the cartridge stores some kind of detergent, pesticide, or any other component that should be diluted with water.

According to a further embodiment the cartridge comprises a flexible cartridge container and a solid head part with the head part being configured to be attached to the spray applicator. Such a flexible cartridge container is usually lighter than a solid container such that the handling of the spray applicator is made a lot easier. Also, flexible cartridge containers do not take up as much volume as solid containers at least when they are empty as they can be compressed during the process of emptying the cartridge.

It this connection it is noted that the cartridge can further comprise a solid support sleeve configured to receive the flexible cartridge container. Such a support sleeve can for example protect the flexible cartridge container from being damaged.

According to a further embodiment the cartridge further comprises a second flexible cartridge container with the second cartridge container being configured to store another component to be dispensed. The second container can either be arranged coaxially relative to the first container or the two containers can be arranged next to one another. In both cases they can comprise a common head part with a single common outlet or with two outlets, one for each container.

In this connection it should be noted that the dispenser can further be configured to mix the component stored inside the tank with either the component stored inside the first cartridge container or the component stored inside the second cartridge container prior to dispensing the mixture of components.

Alternatively, the dispenser can also be configured to mix the component stored inside the tank with each component of the first and second cartridge prior to dispensing the mixture of components. In this case the dispenser can either mix the components one after the other, i.e. the component from the tank with the component from the first cartridge and the mixture with the component from the second cartridge. Alternatively, the component of the tank can flow to the first and second cartridge simultaneously to mix each component of a cartridge with the component of the tank prior to mixing the two mixtures with one another.

It is also possible that the dispenser is configured to dispense each component independently.

According to a further embodiment of the disclosure the cartridge is arranged next to a dispensing nozzle of the spray applicator. That is, the cartridge can be arranged at the spray applicator right at the dispensing end of the dispenser.

Alternatively (or additionally in the case of two cartridges being present) the cartridge is arranged close to the connection the tank.

According to another embodiment the cartridge can also be arranged inside the tank.

### BRIEF DESCRIPTION OF THE DRAWINGS

The disclosure is further described in connection with the following Figures in which is shown:

FIG. 1 is a dispenser according to the first aspect of the disclosure;

FIG. 2: a simplified side view of the dispenser of FIG. 1;

FIG. 3 is a first embodiment of the dispenser according to the first aspect of the disclosure;

FIG. 4 is a second embodiment of the dispenser according to first aspect of the disclosure;

FIG. 5 is a third embodiment of the dispenser according to the first aspect of the disclosure;

FIG. 6 is a fourth embodiment of the dispenser according to the first aspect of the disclosure;

FIG. 7 is a fifth embodiment of the dispenser according to the first aspect of the disclosure;

FIG. 8 is a sixth embodiment of the dispenser according to the first aspect of the disclosure;

FIG. 9 is a ninth embodiment of the dispenser according to the first aspect of the disclosure;

FIG. 10 is a tenth embodiment of the dispenser according to the first aspect of the disclosure;

FIG. 11 is an eleventh embodiment of the dispenser according to the first aspect of the disclosure;

FIG. 12 is a twelfth embodiment of the dispenser according to the first aspect of the disclosure;

FIG. 13 is a thirteenth embodiment of the dispenser according to the first aspect of the disclosure;

FIG. 14 is a fourteenth embodiment of the dispenser according to the first aspect of the disclosure;

FIG. 15 is a fifteenth embodiment of the dispenser according to the first aspect of the disclosure;

FIG. 16 is a sixteenth embodiment of the dispenser according to the first aspect of the disclosure;

FIG. 17 is a spray applicator according to a second or third aspect of the disclosure;

FIG. 18 is a dispenser according to the second or third aspect of the disclosure;

FIG. 19 is another embodiment of the dispenser according to the second or third aspect of the disclosure;

FIG. 20 is another embodiment of the dispenser according to the second or third aspect of the disclosure; and

FIG. 21 is a dispenser according to the second aspect of the disclosure.

### DETAILED DESCRIPTION

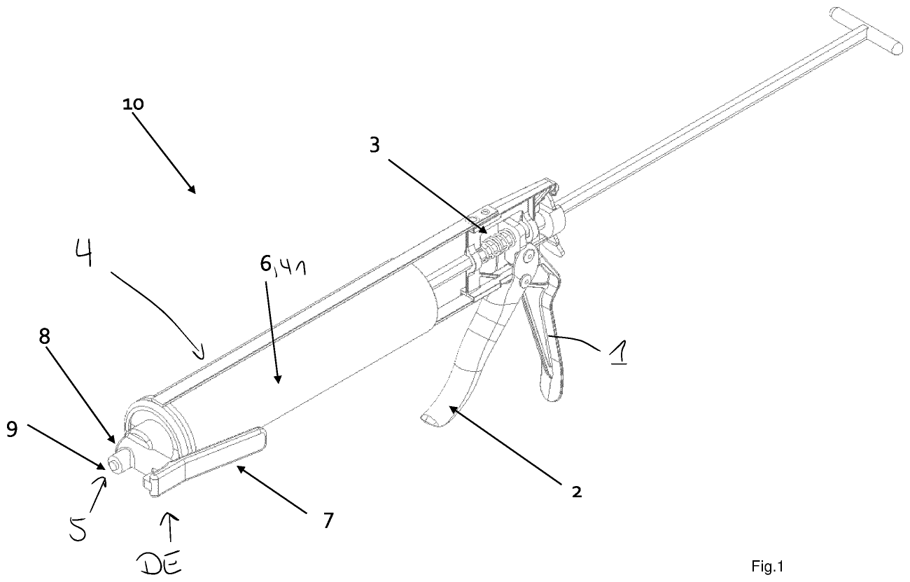

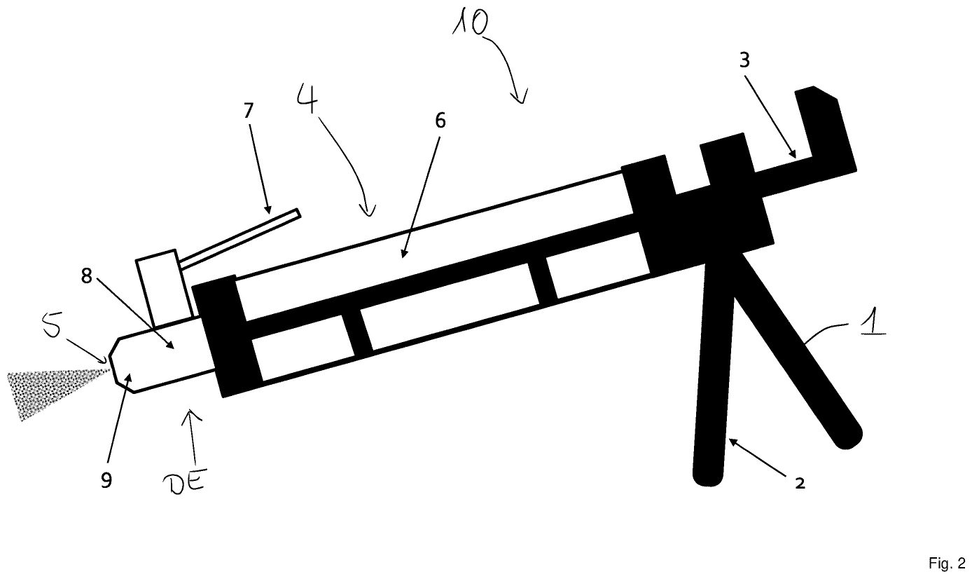

FIG. 1 and particularly FIG. 2 show the most general embodiment of the disclosure according to the first aspect. That is, FIGS. 1 and 2 show a dispenser 10 comprising a dispensing mechanism 3. The dispensing mechanism 3 is configured to move a piston (not shown) along a longitudinal axis of the dispenser such that material stored inside a cartridge 6, which is arranged at the dispensing mechanism, can be dispensed.

In order to initiate such a dispensing motion of the dispensing mechanism 3, the dispenser 10 comprises a trigger 2 which can be arranged, for example, at a handle 1 that is configured to be held by a user.

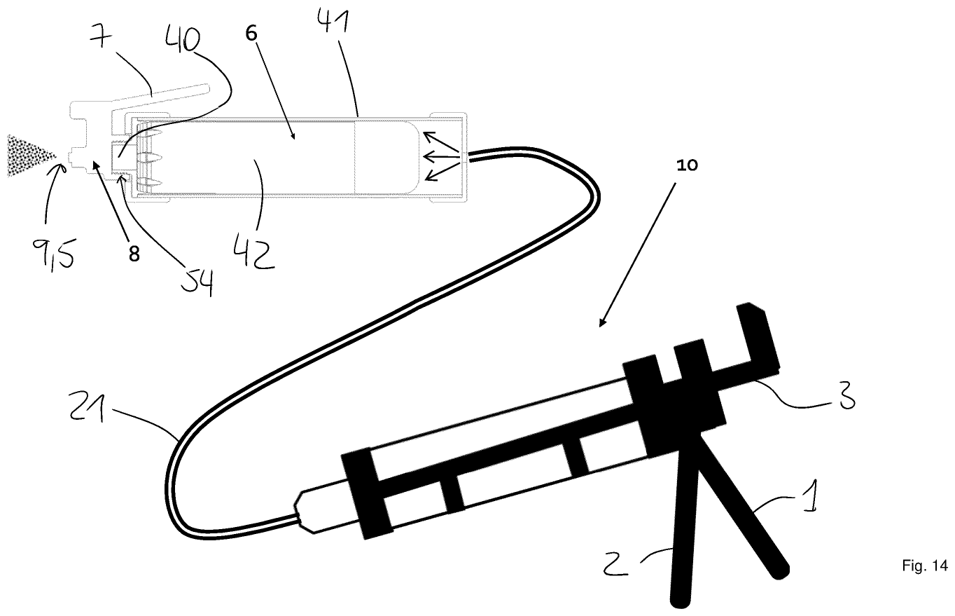

The dispenser 10 further comprises a receptacle 4 configured to, preferably repeatedly, receive the above mentioned cartridge 6. The cartridge 6 usually comprises a solid head 40 part and one of a solid cartridge and a flexible cartridge container 42 (see e.g. FIG. 14 to FIG. 16) that is sealingly connected to the head part 40. The head part 40 further comprises an outlet 44 through which the material stored inside the cartridge 6 can be dispensed.

The cartridge container 42 can be formed of a film material that comprises two or more layers of the same or different material. Furthermore, the cross section of the container 42, and also of the complete cartridge 6, can be one of a round, oval, rectangular, square, triangular and/or polygonal cross section, which is essentially constant along the longitudinal length of the container 42.

Alternatively, it could obviously also be possible that the cartridge container 42 is made of a solid material such that that the solid container 42 is either integrally formed with the head part 40 or formed separately from the head part 40 and then connected to it.

Either way, the material stored inside the cartridge 6 is one of a low viscosity or higher viscosity material which is still liquid enough to be sprayed out of the spray applicator 8.

The cartridge 6 can further comprise an inner volume selected in the range of 100 ml to 10 l depending on the field of application of the dispenser 10.

The cartridge 6 can further comprise a support sleeve 41 that is configured to receive the cartridge and the piston (see e.g. FIG. 14). Such a support sleeve 41 can for example a flexible cartridge container 42 and/or can simplify the insertion and extraction of the cartridge 6 at the dispenser 10.

At a dispensing end DE of the dispenser 10 a spray applicator 8, which is configured to spray the material stored inside the cartridge 6 out of the dispenser 10, is arranged and connected to the dispenser 10, in particular to the outlet 44 of the cartridge 6, by connecting means (not shown). The connection means can for example comprise click- or bayonet connection means, form fitting or traction fitting connection means, single- or multi-start screw threads and/or combinations of the foregoing.

For the purpose of spraying the dispenser 10 comprises a dispensing outlet 5 or an additional dispensing nozzle 9 which can be seen in FIG. 1, for instance.

The dispenser 10 can generally be one of a manual, electrical, in particular cordless, and pneumatic dispenser. Hence, there are generally no limitations regarding the choice of drive mechanism of the dispenser.

As can be further seen in FIGS. 1 and 2, the dispenser according to the first aspect of the disclosure can also comprise a lever 7 which is configured to activate the spray applicator 8. That is, it can be possible that the trigger 2 only triggers a movement of the dispensing mechanism 3 to produce a pressure at the dispensing end DE of the dispenser. Only by then bringing the lever 7 into an activated position the dispenser 10, i.e. the spray applicator 8, then releases the material such that it is sprayed out of the dispensing nozzle 9.

The lever 7 can further comprise locking mechanism (not shown) configured to lock the lever 7 in at least one of a spraying and storing position. Furthermore, it can be possible that the lever 7 is configured to continue spraying the material out of the dispenser 10 as long as the lever 7 is activated. Alternatively, the lever 7 can be configured to release only one puff of material when it is activated independently of how long the lever 7 is kept in the activated position.

As can be seen in FIG. 1 and FIG. 2, the lever 7 is arranged at the spray applicator 8 in the near vicinity of the spraying nozzle 9. Alternatively, the lever could also be arranged at the trigger 2 and/or the handle 1 or at a different position of the dispenser 10 that is convenient for the user.

Additionally, the dispenser 10 can comprise a valve assembly (not shown) that is arranged at the dispensing end DE of the dispenser 10 and which is configured to spray the material stored in the cartridge 6 out of the spraying nozzle 9.

The valve assembly can for example be controlled by a further lever, a rotary control element and/or a press control element.

Also, it can be possible that the dispenser 10 according to the disclosure comprises carrying means (not shown) that allow an on-body carrying for the user. Such carrying means can for example comprise a clip, in particular a belt clip, a strap, in particular a shoulder strap, a belt, a sling, a buckle and/or combinations of the foregoing.

According to FIGS. 1 and 2 the spray applicator 8 according to the disclosure is directly arranged at the cartridge 6 and/or the receptacle 4 of the dispenser 10. However, as can be seen in the following embodiments, this must necessarily be the case.

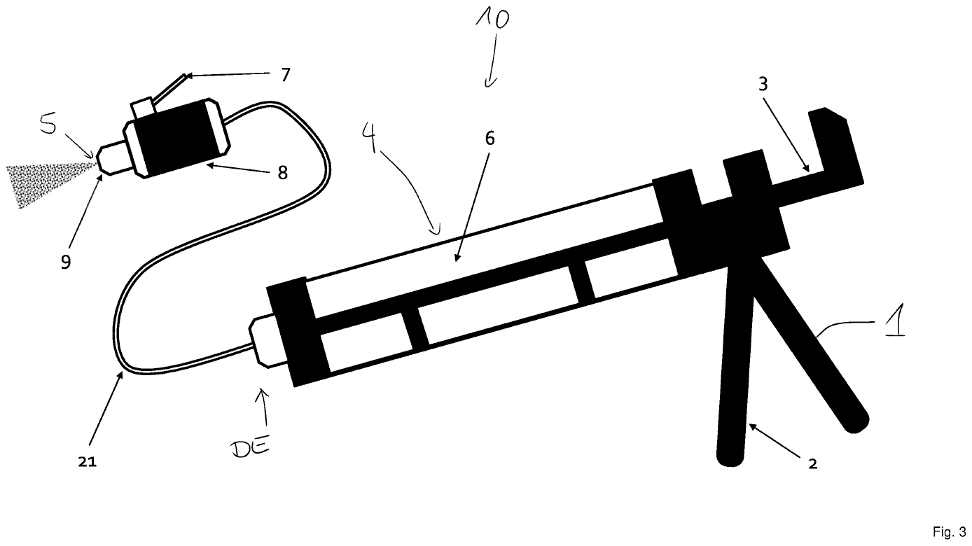

FIG. 3 shows an embodiment of the dispenser according to the first aspect of the disclosure which comprises an additional tube 21 that is arranged between the spray applicator 8 and the rest of the dispenser 10, in particular the outlet of the cartridge 6.

This embodiment allows the user to spray the material onto surfaces and regions that are difficult to reach as they do not have to bring the complete dispenser 10 at the respective region, such as for example a ceiling or the like.

With the embodiment of FIG. 3 it can rather be possible to carry the dispenser 10 with a belt or the like such that only the spray applicator 8 needs to be moved close to the region that is supposed to be sprayed or to not even carry the dispenser 10 at all.

Either way, a length of the tube 21 can be chosen as needed and can thus vary.

FIG. 3 further shows that again the lever 7 can be arranged at the spray applicator near to the spraying nozzle 9 of the spray applicator 8 such that the nozzle 9 can be directly controlled by the lever 7.

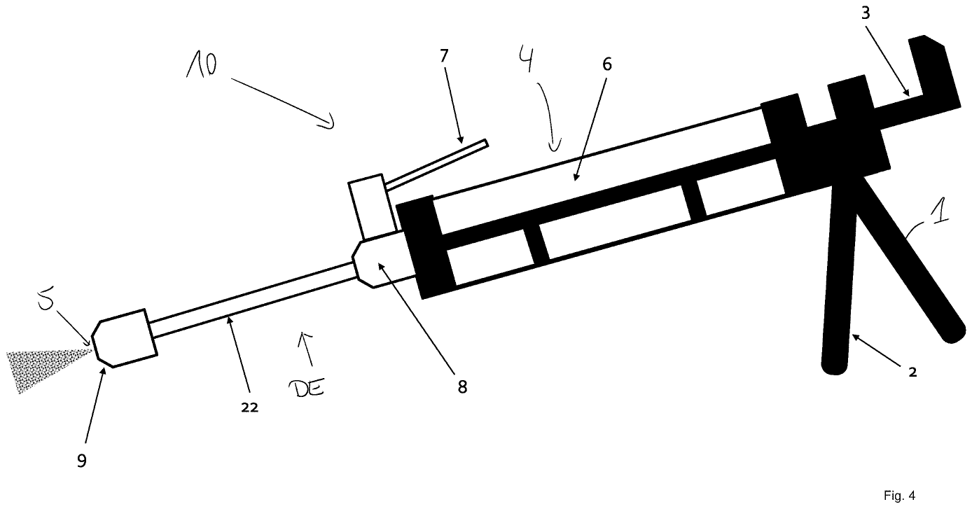

According to FIG. 4 the dispenser 10 comprises a pipe 22 instead of a tube 21 between the spraying nozzle 9 and the rest of the dispenser 10. The pipe 22 is more rigid than the generally flexible tube 21. That is, in this case the pipe 22 is configured to extend a length between the spraying nozzle 9 and the rest of the spray applicator 8 such that the spray applicator 8 is still arranged at the dispensing end DE of the dispenser 10.

Such an embodiment can be advantageous when only a longitudinal length of the dispenser 10 is supposed to be extended in order to reach remote spaces, corners or bottlenecks of any kind.

According to FIG. 4 the lever 7 is still arranged at the spray applicator 8. However, it is not arranged in the near vicinity of the spraying nozzle 9 but rather at a rear end of the pipe 22.

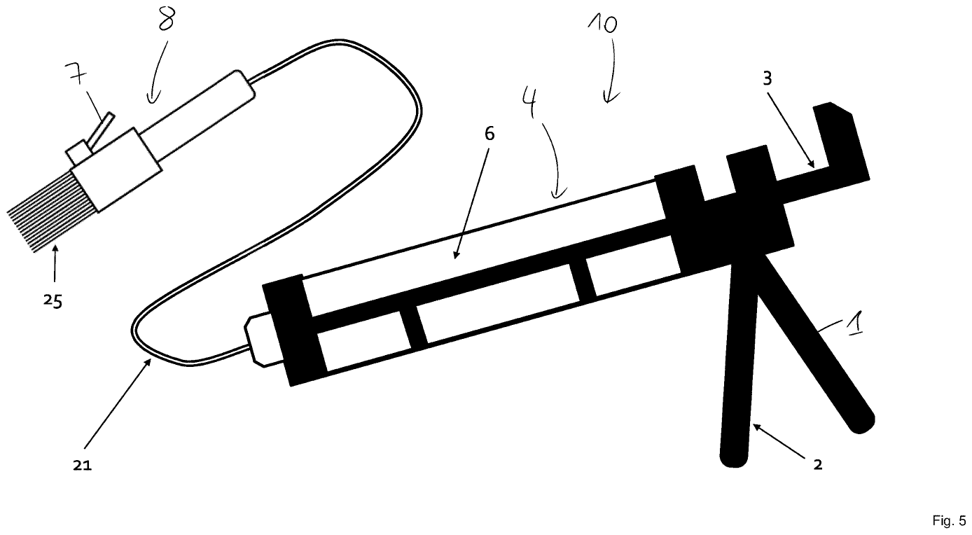

The embodiment shown in FIG. 5 is similar to the embodiment of FIG. 3. However, the dispenser 10, in particular the spray applicator 8, according to FIG. 5 comprises an additional brush 25 that is configured to distribute the material onto a surface. As can be seen the brush 25 is arranged at a front end of the tube 21.

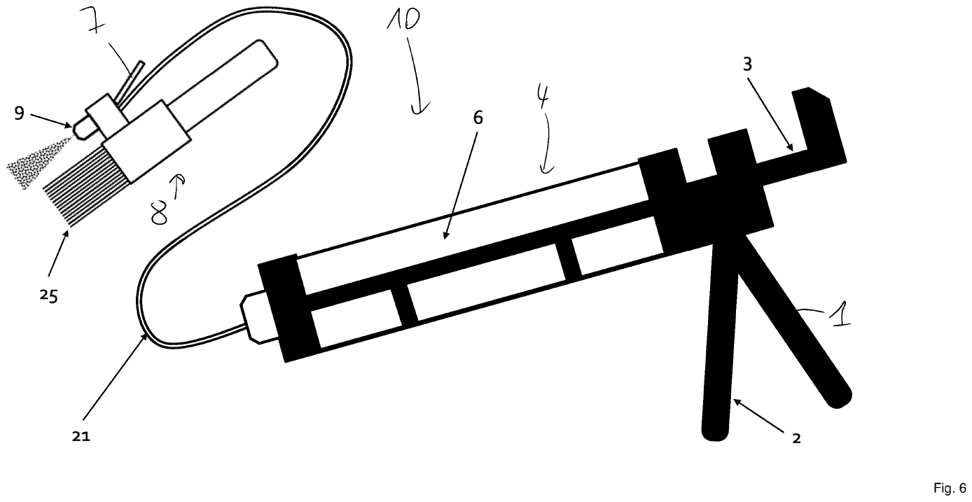

In this case the spray applicator 8 does not necessarily need a spraying nozzle 9, as it is for example shown in FIG. 6. According to FIG. 5 the brush 25 can rather be fed by the spray applicator 8 such that the material directly flows into the brush 25 with which it is then distributed on a surface.

The feeding can again be regulated by the lever 7 which is arranged next to the brush 25.

As already mentioned above, FIG. 6 generally shows the same embodiment as FIG. 5 with the only difference that the spray applicator 8 comprises an additional spraying nozzle 9 which sprays the material out of the dispenser 10. The spraying nozzle 9 is arranged right next to the brush 25 such that the sprayed material can immediately be distributed evenly by the brush 25.

The spraying nozzle 9 is again controlled by the lever 7 which is arranged at the spraying nozzle 9 such that it can be activated by the user without having to carry the complete dispenser 10.

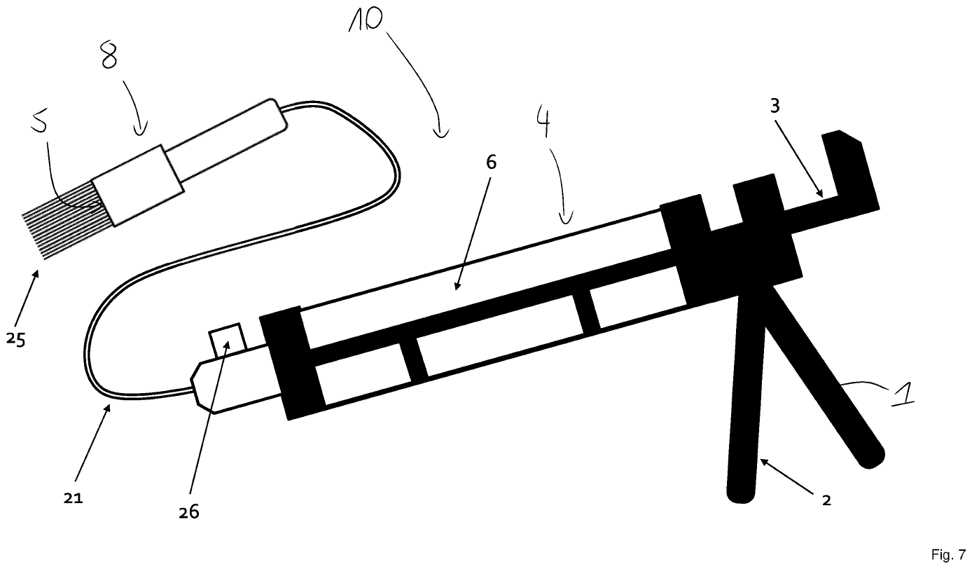

Also FIG. 7 shows a similar embodiment as FIG. 5 with the difference that the embodiment of FIG. 7 includes flow control valve 26 that is configured to regulate the flow of material towards the brush 25. That is, in this embodiment the flow control valve 26 adopts the function of regulating the amount of material flowing towards the brush 25 and/or whether material can flow towards the brush 25 at all.

Therefore, the embodiment of FIG. 7 misses the lever 7 which has been shown in connection with the above embodiments. However, it could nevertheless be possible that the dispenser 10 comprises both a flow control valve 26 and a lever 7.

According to FIG. 7 the flow control valve 26 is arranged at the dispensing end DE of the dispenser 10, in particular at the outlet of the cartridge 6. Generally, the flow control valve 26 could be placed anywhere between the outlet of the cartridge 6 and the brush 25 and/or the dispensing nozzle 9 of the dispenser 10. Here, the control valve 26 is placed such that it controls the amount of material flowing from the cartridge 6 into the tube 21 which then feeds the brush 25 with the material.

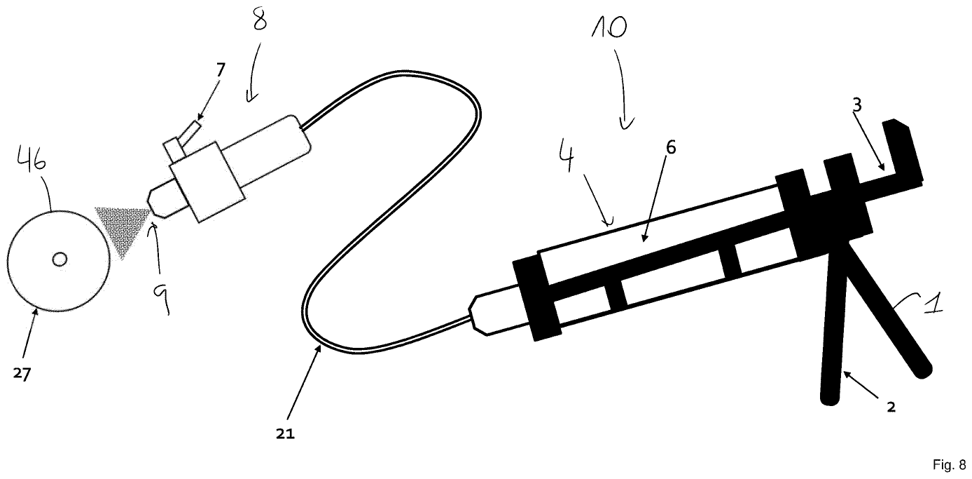

The embodiment of FIG. 8 shows a dispenser 10 according to FIG. 3 with an additional roller 27 being arranged at the spray applicator 8. The roller 27 is configured to distribute the material evenly on a surface and is arranged such that the spray applicator 8 can spray the material onto an exterior surface 46 of the roller 27.

For the sake of simplicity the attachment of the roller 27 at the spray applicator 8 is not shown but it is noted that it can be realized in any known manner, for example by shaft or the like.

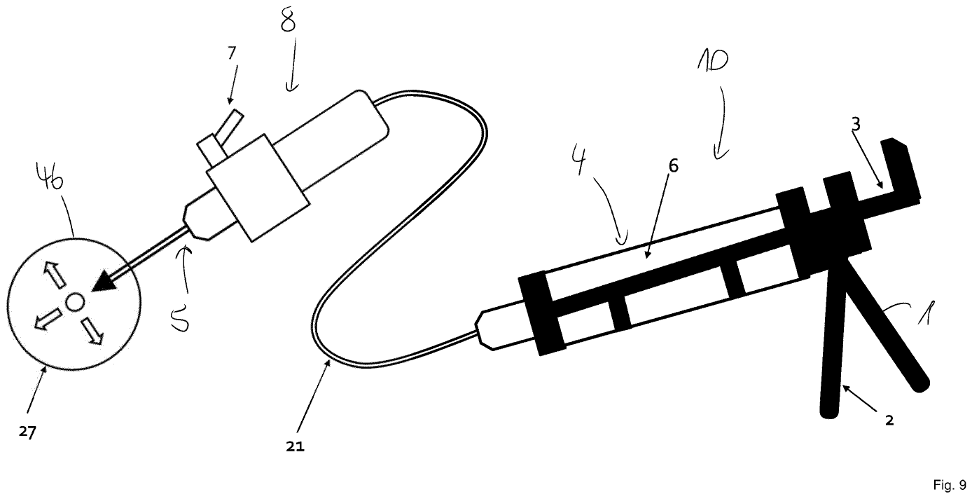

Also the embodiment of FIG. 9 includes a roller 27 at the spray applicator 8 that is configured to distribute the material evenly onto a surface.

However, according to this embodiment the spray applicator 8 does not spray the material onto an exterior surface 46 of the roller 27 but rather feeds the roller 27 with the material, as indicated by the arrow of FIG. 9. By feeding the roller 27 with the material, for example at a central axis of the roller 27, it can be ensured that the complete roller 27, in particular the complete exterior surface 46 of the roller 27 is wetted with material thereby allowing a smooth and even spread of the material.

The two embodiments of FIGS. 8 and 9 both comprise a lever 7 but no flow control valve 26. It could always be possible that the lever 7 is replaced with the flow control valve 26 or that a flow control valve is additionally present to regulate the flow of material to the roller 27.

In this connection it should be noted that the roller 27 is generally configured to rotate about an axis of rotation. For this purpose the roller 27 is mounted in such a way that it can rotate about the axis of rotation, e.g. about a central shaft or between two hinges having a respective roller mount.

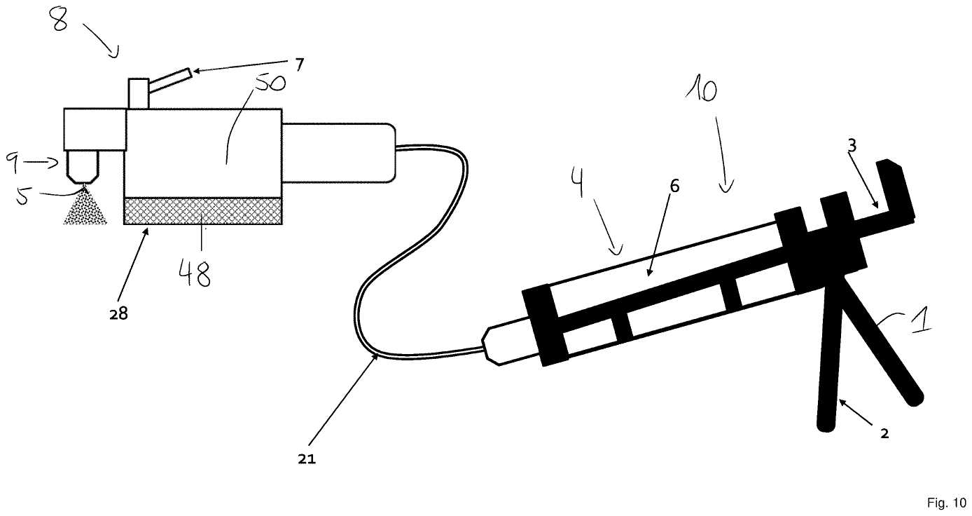

FIG. 10 shows an embodiment that is similar to the embodiment of FIG. 3 with an additional polishing tool 28 being arranged at the spray applicator 8. The polishing tool is configured to evenly distribute the material onto a surface.

It can be seen that according to FIG. 10 the polishing tool 28 is arranged between the tube 21 and the dispensing outlet 5 of the spray applicator 8. That is, upon use the spray applicator 8 sprays the material out of the dispensing outlet 5 onto a surface and the polishing tool 28 then distributes the sprayed material evenly.

Obviously it could also be possible that the position of the dispensing outlet 5 and the polishing tool 28 are interchanged with one another or that the spray applicator 8 is configured to directly feed the polishing tool 28 with the material without spraying it separately.

The polishing tool 28 comprises a polishing element 48 and a holding element 50 configured to be held by a user such that the polishing element 48 can be brought into contact with the surface that is supposed to be sprayed/coated with the material. In this connection it is noted that the holding element 50 can be part of the spray applicator 8.

In this connection it should be noted that the polishing tool 28 is configured to carry out rotational movements, sliding movements and/or oscillating movements at the surface to be treated.

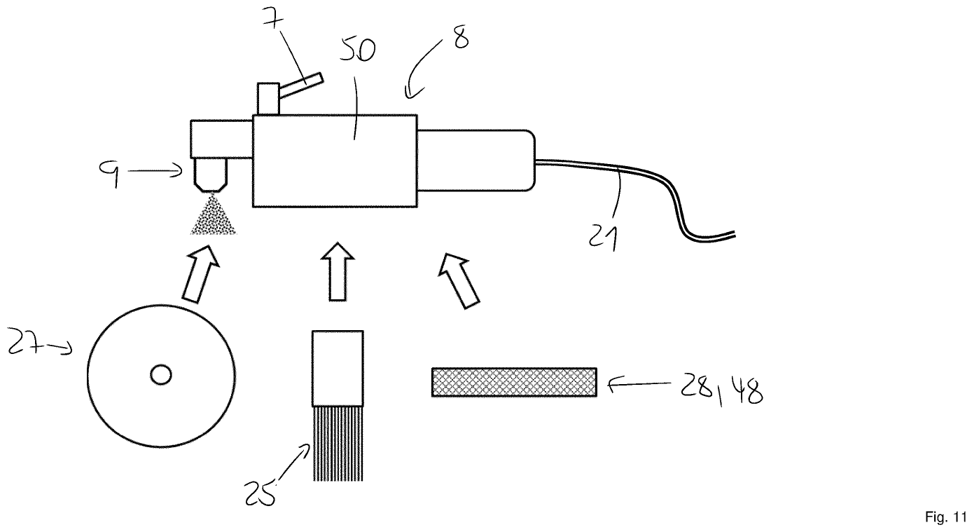

As can be seen from FIG. 11, the above embodiments, i.e. the brush 25, the roller 27 and the polishing tool 28—or at least the polishing element 48 of the polishing tool 28 can be incorporated in a single embodiment as accessories by being interchangeable with one another such that a user can chose which element to use in dependence on the desired task.

Furthermore, it is also possible that the tube 21 and pipe 22 of the above mentioned embodiments are detachable from the dispenser 10 and/or the spray applicator 8. This can allow the spray applicator 8 to be used independently from the rest of the dispenser 10 after material has flown into the spray applicator 8. It can further allow a more flexible use of the dispenser 10 as one can choose freely whether to your use the tube 21 or the pipe 22 or not.

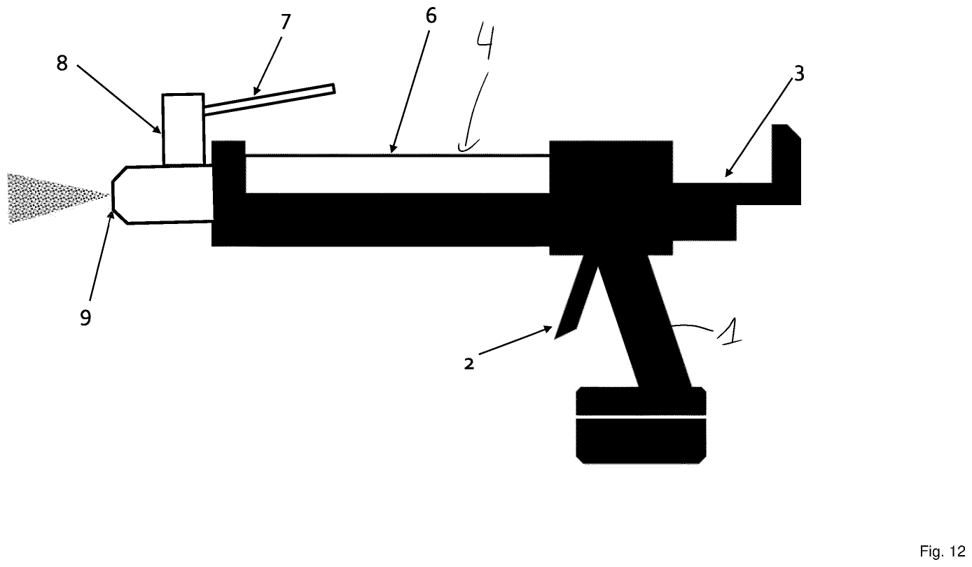

FIG. 12 shows a further embodiment that generally corresponds with the embodiment of FIG. 3 with the sole difference that FIG. 12 depicts a cordless electric dispenser 10 while FIG. 3 depicts a manual dispenser 10.

This can be seen at the handle 1 that includes a battery pack 52 which is configured to drive the dispenser 10 and thus the dispensing mechanism 3.

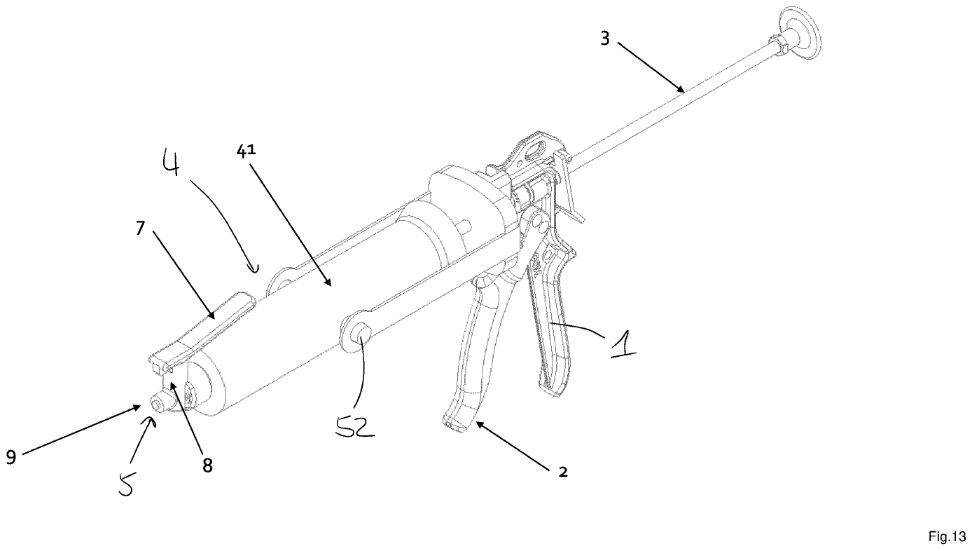

FIG. 13 shows another embodiment of a manual dispenser 10 that includes a receptacle 4 which holds the support sleeve 41. According to this embodiment, the cartridge 6 (which cannot be seen in this Figure) can be inserted from a rear end of the support sleeve 41, i.e. from the end facing the handle 1 and the trigger 2, such that the outlet 44 of the cartridge 6 faces the spray applicator 8 with the dispensing nozzle 9.

This can be done by rotating the support sleeve 41 around pins 52 such that the rear end of the sleeve 41 can be reached. After insertion or extraction of the cartridge 6, the sleeve 41 can then be rotated back into the receptacle 4 such that the dispenser 10 can be used.

According to a further embodiment, as depicted in FIG. 14, the cartridge 6 can also be arranged at the spray applicator 8 such that the dispenser 10 is merely used for applying pressure onto a piston or the rear end of the cartridge 6.

In the embodiment shown in FIG. 14 the cartridge 6 is covered by a support sleeve 41 since the cartridge container 42 is made out of a flexible material. This way, the dispenser 10 only needs to apply pressure onto the rear end of the cartridge container 42 (as indicated by the arrows) such that the flexible container 42 is compressed towards the head part 40 thereby urging the material stored in the cartridge 6 out of the outlet 44 and thus out of the spray applicator 8.

This embodiment can be particularly suitable for a great variety of applications as one and the same dispenser 10 can be used in connection with different cartridges 6 and/or different materials to be sprayed as only the spray applicator 8 and/or the cartridge 6 needs to be replaced.

Furthermore, it can also be seen in FIG. 14 that the spray applicator 8 can comprise a threaded connection 54 with the support sleeve 41 such that the spray applicator 8 can easily be detached from the support sleeve 41 and thus the cartridge 6 to allow an easy exchange of the cartridge 6.

In this connection it is noted that also other connection means could be possible to allow the spray applicator 8 to be detachable from the support sleeve 41.

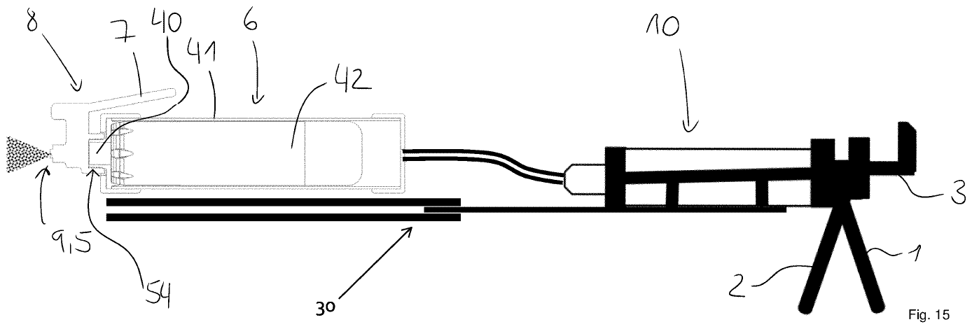

FIG. 15 shows generally the same embodiment as FIG. 14. This embodiment additionally includes a further telescopic arm 30 which holds the spray applicator 8 and the support sleeve 41 such that a user does not need to hold both the dispenser 10 and the cartridge 6. Nevertheless, with the telescopic arm 30 the range of the dispenser 10 can be noticeably increased to provide an easier use of the dispenser 10.

In this connection it should be noted that the telescopic arm 30 can be configured to hold and support the spray applicator 8 and the support sleeve 41, in such a way that the spray applicator 8 and the support sleeve 41 can also be used on their head without the danger rising that one or more of the spray applicator 8 and the support sleeve 41 fall off from the telescopic arm 30.

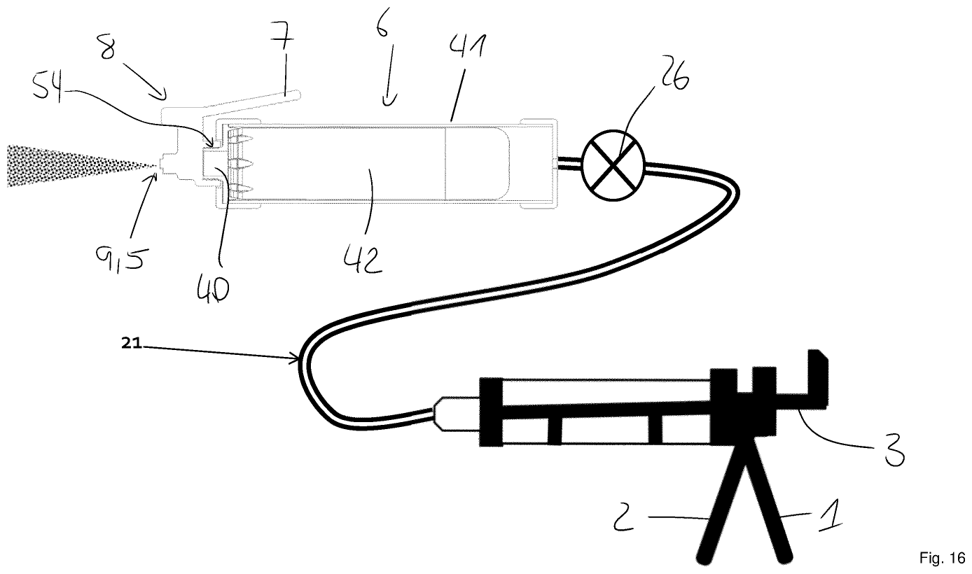

FIG. 16 also shows generally the same embodiment as FIG. 14. According to this embodiment the dispenser 10 further includes an additional valve, such as for example the flow control valve 26, that allows the tube 21 to be detached from the support sleeve 41/the cartridge 6 such that the spray applicator 8 (together with the cartridge 6) can be used without the rest of the dispenser 10.

In this connection it should be noted that the additional valve shown in FIG. 16 can also be included between the spray applicator 8 and the dispenser 10 of FIG. 14.

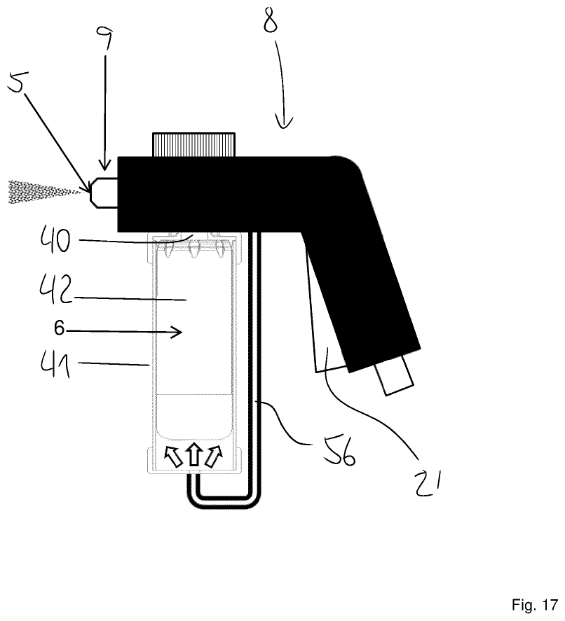

A further spray applicator 8 that can be used in connection with the above and the following embodiments is depicted in FIG. 17. The spray applicator according to FIG. 17 includes a spraying nozzle 9 configured to spray the material. Furthermore, the cartridge 6 is directly attached to the spray applicator by a support sleeve 41 which can be connected to the spray applicator 8.

It can further be seen that the spray applicator 8 comprises an additional connection tube 56 which directs the pressure that is applied by the dispenser 10 onto the rear end of the cartridge 6 (as depicted with the arrows) such that the material stored inside the cartridge is urged towards the outlet 44 and thus out of the spraying nozzle 9.

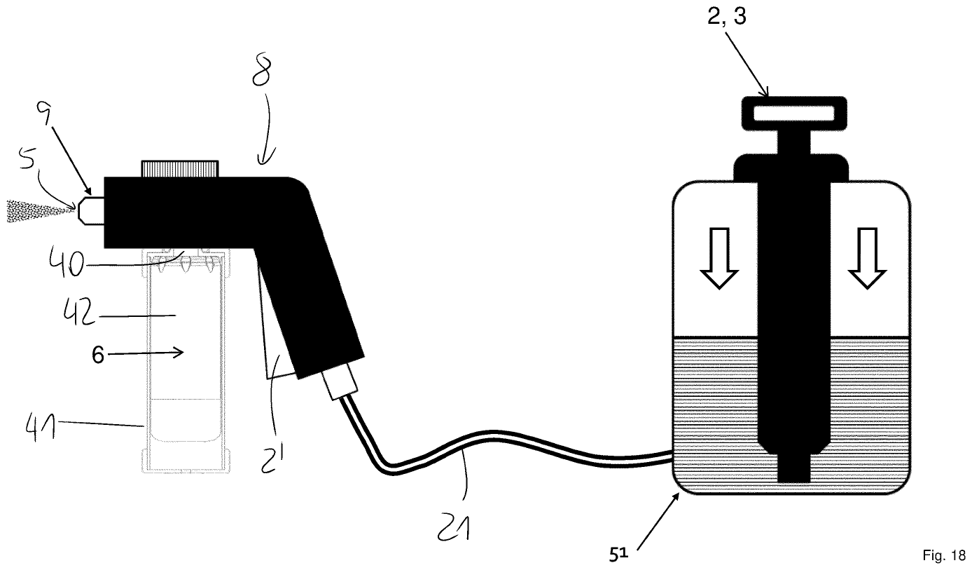

A further aspect of the disclosure is shown in FIG. 18 which shows a dispenser 10 comprising a dispensing mechanism 3, a spray applicator 8 with a spraying nozzle 9 and a cartridge 6 which is directly connected to the spray applicator 8.

According to this further aspect the dispenser 10 further comprises a tank 51 to which the dispensing mechanism 3 is attached to. In this case the dispensing mechanism 3 is a manual dispensing mechanism 3. However, generally it could also be one of an electrical or pneumatic mechanism.

The cartridge 6 comprises a flexible cartridge container 42 with a solid head part 42, wherein the container 42 is surrounded by support sleeve 41. The cartridge container 42 stores a material to be sprayed.

The tank 51 stores another material to be dispensed, which can be a different material. Upon use of the dispenser 10 by activating the trigger 2, pressure can be built up in the tank 51 such that the material stored therein is urged through the tube 21 that connects the tank with the spray applicator 8.

It can further be seen that in this embodiment the spray applicator 8 comprises another trigger 2′that is configured to activate the spraying of the two materials, i.e. the material coming from the tank 51 and the material stored inside the cartridge 6 with the two materials being mixed with one another before or while being sprayed out of the spraying nozzle 9.

According to this embodiment of the disclosure, the user only has to carry the spray applicator 8 with them while the tank 51 can rest at a fixed position. Therefore, the tube 21 connecting the spray applicator 8 with the tank 51 comprises a suitable length that allows the user to move.

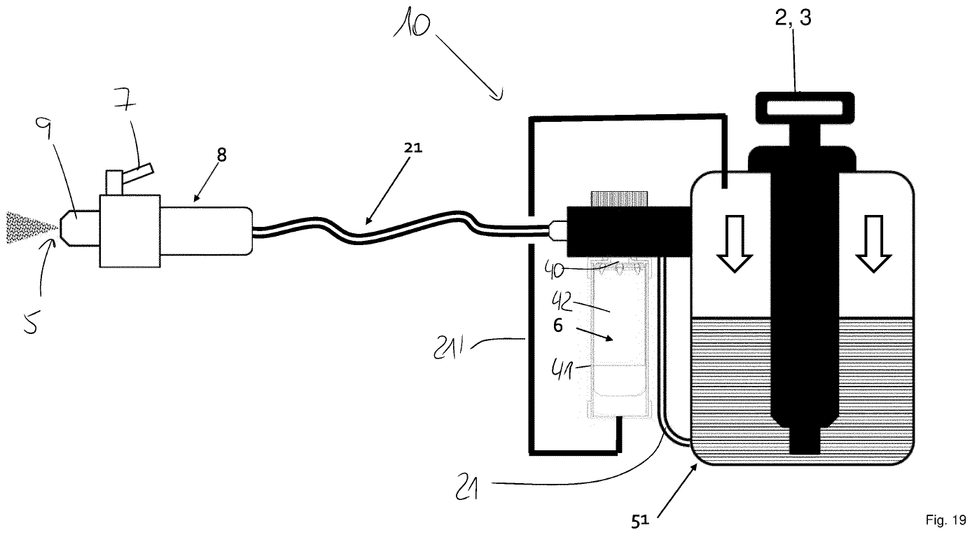

According to a further embodiment, which can be seen in FIG. 19, the cartridge 6 can also be attached right next to the tank 51 such that a user only needs to carry the spray applicator 8 without having to additionally carry the cartridge 6 with them.

According to this embodiment, the cartridge 6 is connected to the tank 51 via a further tube or pipe 21′ such that the pressure which is built up in the tank 51 via the dispensing mechanism 3 not only urges the material stored inside the tank 51 into tube 21 but the pressure also urges the material stored inside the cartridge 6 into the tube 21. This way, the two materials can already be mixed with one another inside tube 21 before entering the spray applicator 8 with which the mixture can then be sprayed.

In order to activate the spray applicator 8, the embodiment of FIG. 19 comprises a lever 7 that is attached to the spray applicator 8. Hence, the dispensing mechanism 3 is used to build up pressure and the lever 7 is used to release, i.e. spray, the mixture of materials out of the dispensing nozzle 9.

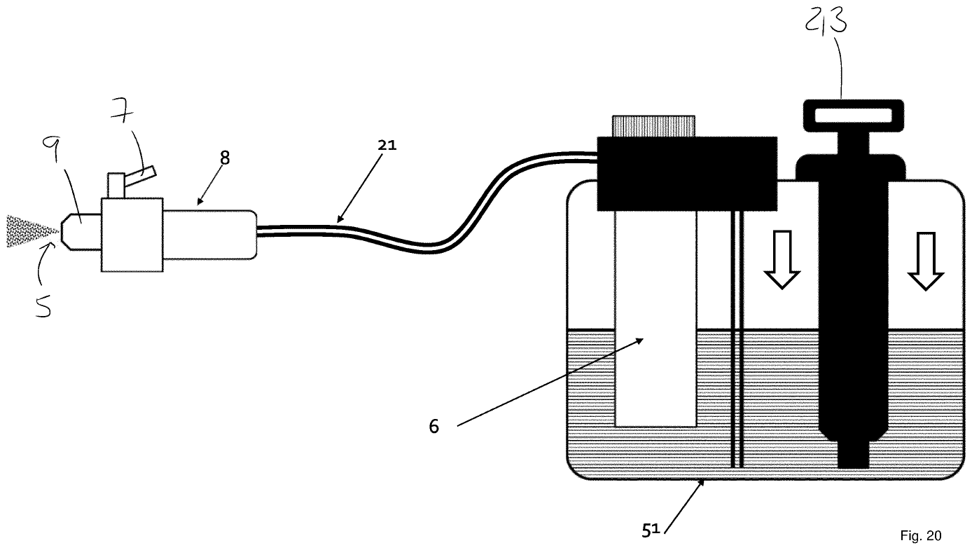

A further embodiment of the disclosure is shown in FIG. 20 where one can see that the cartridge 6 can also be arranged directly inside the tank 51. In this case, no further connection lines between the tank 51 and the cartridge 6 are needed as the pressure, which is built up inside the tank 51 can already directly act on the cartridge 6.

According to this embodiment it can be advantageous when the cartridge 6 only comprises a flexible cartridge container 42 and a solid head part 40 without the container 42 being surrounded by a support sleeve 41. Alternatively, it can also be possible that the cartridge container 42 is made out of solid material such that it is not deformed when pressure is being build up inside the tank.

The spray applicator 8 and the tube 21 are generally the same as in FIG. 19.

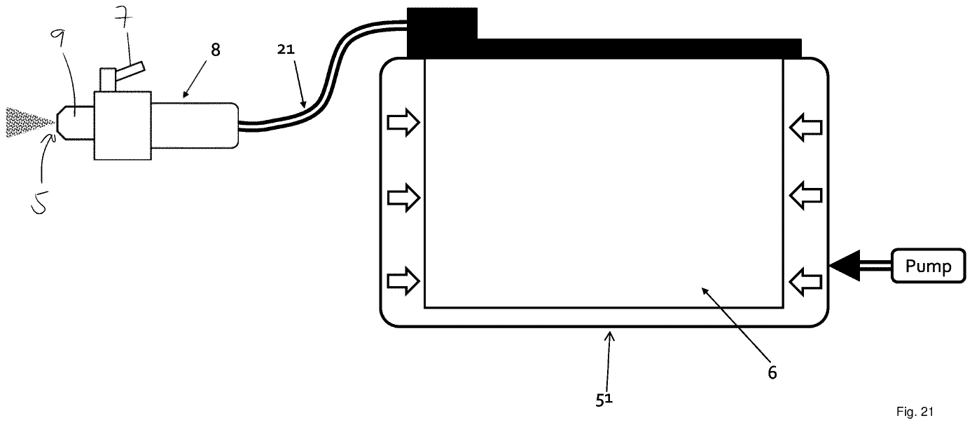

FIG. 21 shows a further embodiment where a cartridge 6 is arranged inside the tank 51. According to this embodiment the dispenser 10 further comprises an external pump that is used to build up pressure inside the tank 51 such that the cartridge 6, which holds the material to be dispensed, is compressed and the material stored therein is urged towards the tube 21 and into the spray applicator 8.

Hence, according to this embodiment the dispenser 10 only comprises one material to be dispensed, i.e. sprayed. The spray applicator 8 is again the same as in FIGS. 19 and 20 and thus not described here again.

However, generally it is noted that all of the above embodiments regarding the different spray applicators 8 can be applied to all of the above mentioned dispensers 10 and cartridges 6.

That is, it is not relevant whether a dispenser 10 according to the first aspect of the disclosure or a dispenser 10 according to the second and third aspect of the disclosure is being used, the different spray applicators 8 can be used in all three dispensers.

1. A dispenser for dispensing at least one component of material, comprising:
at least one cartridge configured to store the material to be dispensed;
a dispensing mechanism configured to urge the material towards an outlet of the cartridge; and
a trigger configured to activate the dispensing mechanism;
a connection device at a dispensing end of the dispenser configured to, connect the dispenser to a spray applicator, with the spray applicator being configured to spray the material out of the cartridge.

2. The dispenser according to claim 1,
wherein the dispenser is one of a manual, electrical and pneumatic dispenser.

3. The dispenser according to claim 1,
wherein the trigger is configured to enable a longitudinal movement of a piston towards the outlet of the cartridge.

4. The dispenser according to claim 1,
wherein the cartridge comprises a solid head part and a flexible cartridge container being sealingly connected to the solid head part, with the head part comprising the outlet of the cartridge.

5. The dispenser according to claim 4,
wherein the flexible container is formed of a film material.

6. The dispenser according to claim 5,
wherein the film material is formed of two or more layers with the layers being made of the same or different materials.

7. The dispenser according to claim 5,
wherein the flexible container comprises one of a round, oval, rectangular, square, triangular, polygonal cross section.

8. The dispenser according to claim 5,
wherein a cross section of the flexible container is essentially constant along a longitudinal length of the flexible container.

9. The dispenser according to claim 1,
wherein the cartridge comprises a solid cartridge container and a solid head part, with the head part being integrally formed with the container.

10. The dispenser according to claim 1,
wherein the material stored inside the cartridge is either one of low viscosity or higher viscosity material.

11. The dispenser according to claim 1,
wherein the cartridge comprises an inner volume selected in the range of 100 ml to 10 1.

12. The dispenser according to claim 1,
further comprising a carrying device configured to enable on-body carrying of the dispenser.

13. The dispenser according to claim 12,
wherein the carrying device is one of a clip, a strap, a belt, a sling, a buckle or a combination thereof.

14. The dispenser according to claim 1,
further comprising a support sleeve configured to receive the cartridge and a piston configured to apply a pressure onto a rear end of the cartridge to urge the material stored inside the cartridge towards the outlet.

15. The dispenser according to claim 1,
wherein the spray applicator comprises a valve assembly arranged at a dispensing end of the dispenser and is configured to spray the material out of the dispenser.

16. The dispenser according to claim 15,
wherein the valve assembly is configured to be controlled by a lever, a rotary control element or a press control element.

17. The dispenser according to claim 1,
wherein the spay applicator further comprises a lever configured to activate the spray applicator and is connectable to the spray applicator upon use of the dispenser.

18. The dispenser according to claim 17,
wherein the lever comprises a locking mechanism configured to lock the lever in at least one of a spraying and a storing position.

19. The dispenser according to claim 17,
wherein the lever being further configured to continue spraying the material out of the dispenser as long as the lever is activated.

20. The dispenser according to claim 1
wherein the spray applicator further comprises a spraying nozzle with the spraying nozzle being connectable to the spray applicator.

21. The dispenser according to claim 17,
wherein the lever is arranged at the spraying nozzle.

22. The dispenser according to claim 1,
wherein the spray applicator is connected to the dispenser via a tube with a length of the tube being selected in the range of 5 cm to 2 m.

23. The dispenser according to claim 22,
wherein the tube is detachable upon use of the spray applicator.

24. The dispenser according to claim 1,
wherein the spray applicator comprises an extension pipe configured to extend a length between at least a part of the spray applicator and other parts of the dispenser.

25. The dispenser according to claim 1,
wherein the spray applicator comprises a brush arranged at a dispensing end of the dispenser.

26. The dispenser according to claim 25,
wherein the spraying nozzle is arranged next to the brush.

27. The dispenser according to claim 25,
wherein the brush is fed with material by the spray applicator.

28. The dispenser according to claim 25
further comprising a flow control valve configured to regulate the flow of material towards the brush.

29. The dispenser according to claim 25,
wherein the brush is releasably attachable to the spray applicator.

30. The dispenser according to claim 1,
wherein the spray applicator comprises a roller onto which the material is sprayed, with the roller being configured to evenly distribute the material onto a surface.

31. The dispenser according to claim 1,
wherein the spray applicator additionally comprises a roller which is fed with material by the spray applicator with the roller being configured to evenly distribute the material onto a surface.

32. The dispenser according to claim 30,
wherein the spray applicator is configured to feed the roller at a central axis of the roller with said the central axis extending along a longitudinal length of the roller.

33. The dispenser according to claim 39,
wherein the roller is releasably connectable to the spray applicator.

34. The dispenser according claim 1,
wherein the spray applicator comprises a polishing tool configured to evenly distribute the material onto a surface.

35. The dispenser according to claim 34,
wherein the spraying nozzle is arranged next to the polishing tool.

36. The dispenser according to claim 34,
wherein the polishing tool is releasably attachable to the spray applicator.

37. The dispenser according to claim 34
wherein the polishing tool is configured to vibrate or move back and forth or rotate upon use of the dispenser.

38. The dispenser according to claim 1,
further comprising a telescopic arm, configured to extend a length between the dispenser and at least the spray applicator.

39. A dispenser for dispensing at least one component of material, comprising:
at least one tank configured to store the material to be dispensed:
a dispensing mechanism configured to urge the material towards an outlet of the tank;
a trigger configured to activate the dispensing mechanism; and
a connection device at the outlet of the tank configured to, connect the dispenser to a spray applicator with the applicator being configured to spray the material out of the tank.

40. The dispenser according to claim 39,
wherein the tank is configured to be pressurized by one of a manual pump, an electrical pump, a central air supply or pressurized bottles.

41. The dispenser according to claim 39,
further comprising a cartridge configured to store at least a second material and with the cartridge further being configured to be, connectable to the spray applicator or to the tank.

42. The dispenser according to claim 41,
wherein the flexible container is formed of a film material.

43. The dispenser according to claim 42,
wherein the film material is formed of two or more layers with the layers being made of the same or different materials.

44. The dispenser according to claim 42,
wherein the flexible container comprises one of a round, oval, rectangular, square, triangular, or polygonal cross section.

45. The dispenser according to claim 1,
wherein a cross section of the flexible container is essentially constant along a longitudinal length of the flexible container.

46. The dispenser according to claim 41,
wherein the cartridge comprises a solid cartridge container and a solid head part, with the head part being integrally formed with the container.

47. The dispenser according to claim 39,
wherein the material stored inside the tank or the cartridge is one of low viscosity or higher viscosity material.

48. The dispenser according to claim 39,
wherein the tank or the cartridge comprises an inner volume selected in the range of 100 ml to 100 l.

49. The dispenser according to claim 39,
further comprising a carrying device configured to enable on-body carrying of the spray applicator.

50. The dispenser according to claim 49,
wherein the carrying device is one of a clip, a strap, a belt, a sling, a buckle or a combination thereof.

51. The dispenser according to claim 39,
wherein the spray applicator comprises a valve assembly arranged at a dispensing end of the dispenser and configured to spray the material out of the dispenser.

52. The dispenser according to claim 51,
wherein the valve assembly is configured to be controlled by a lever, a rotary control element or a press control element.

53. The dispenser according to claim 39,
wherein the spray applicator further comprises a lever configured to activate the spray applicator and is connectable to the spray applicator upon use of the dispenser.

54. The dispenser according to claim 53,
wherein the lever comprises a locking mechanism configured to lock the lever in at least one of a spraying and a storing position.

55. The dispenser according to claim 53, wherein
the lever is further configured to continue spraying the material out of the dispenser as long as the lever is activated.

56. The dispenser according to claim 39,
wherein the spray applicator further comprises a spraying nozzle with the spraying nozzle being connectable to the spray applicator.

57. The dispenser according to claim 53,
wherein the lever is arranged at the spraying nozzle.

58. The dispenser according to claim 39,
wherein the spray applicator is connected to the dispenser via a tube with a length of the tube being selected in the range of 5 cm to 10 m.

59. The dispenser according to claim 58,
wherein the tube is detachable upon use of the spray applicator.

60. The dispenser according to claim 39,
wherein the spray applicator comprises an extension pipe configured to extend a length between at least a part of the spray applicator and other parts of the dispenser.

61. The dispenser according to claim 39,
wherein the spray applicator comprises a brush arranged at a dispensing end of the dispenser.

62. The dispenser according to claim 61,
wherein the spraying nozzle is arranged next to the brush.

63. The dispenser according to claim 61,
wherein the brush is fed with material by the spray applicator.

64. The dispenser according to claim 61,
further comprising a flow control valve configured to regulate the flow of material towards the brush.

65. The dispenser according to claim 61,
wherein the brush is releasably attachable to the spray applicator.

66. The dispenser according to claim 39,
wherein the spray applicator comprises a roller onto which the material is sprayed, with the roller being configured to evenly distribute the material onto a surface.

67. The dispenser according to claim 39,
wherein the spray applicator comprises a roller which is fed with material by the spray applicator, with the roller being configured to evenly distribute the material onto a surface.

68. The dispenser according to claim 67,
wherein the spray applicator is configured to feed the roller at a central axis of the roller with said the central axis extending along a longitudinal length of the roller.

69. The dispenser according to claim 66,
wherein the roller is releasably connectable to the spray applicator.

70. The dispenser according to claim 39,
wherein the spray applicator comprises a polishing tool configured to evenly distribute the material onto a surface.

71. The dispenser according to claim 70,
wherein the nozzle is arranged next to the polishing tool.

72. The dispenser according to claim 70,
wherein the polishing tool is releasably attachable to the spray applicator.

73. The dispenser according to claim 70,
wherein the polishing tool is configured to vibrate or move back and forth or rotate upon use of the dispenser.

73. The dispenser according to claim 39,
further comprising a telescopic arm configured to extend a length between the tank and at least the spray applicator.

74. A dispenser for dispensing at least one component of material, the dispenser comprising:
at least one tank configured to store a first component to be dispensed;
a dispensing mechanism configured to urge the material towards an outlet of the tank;
a trigger configured to activate the dispensing mechanism; and
a connection device at the outlet of the tank configured to, connect the dispenser to a spray applicator with the applicator being configured to spray the material out of the tank and with the spray applicator further comprising at least one cartridge, with the cartridge comprising a second component to be dispensed,
the dispenser configured to dispense each component independently from one another.

75. The dispenser according to claim 74,
wherein the dispenser is further configured to dispense both components simultaneously.

76. The dispenser according to claim 75,
wherein the dispenser is configured to mix the component stored in the tank with the component stored in the cartridge prior to dispensing the components.

77. The dispenser according to claim 74,
wherein the cartridge comprises a flexible cartridge container and a solid head part with the head part being configured to be attached to the spray applicator.

78. The dispenser according to claim 77,
wherein the cartridge further comprises a solid support sleeve configured to receive the flexible cartridge container.

79. The dispenser according to claim 77,
wherein the flexible cartridge container is a first flexible cartridge container and the cartridge further comprises a second flexible cartridge container with the second cartridge container being configured to store another component to be dispensed.

80. The dispenser according to claim 79,
wherein the dispenser is configured to mix the component stored inside the tank with either the component stored inside the first flexible cartridge container or the component stored inside the second flexible cartridge container prior to dispensing a mixture of components.

81. The dispenser according to claim 79,
wherein the dispenser is configured to dispense each component independently.

82. The dispenser according to claim 74,
wherein the cartridge is arranged next to a dispensing nozzle of the spray applicator.

83. The dispenser according to claim 74,
wherein the cartridge is arranged close to the connection device of the tank.

84. The dispenser according to claim 74,
wherein the cartridge is arranged inside the tank.
